(19) United States
(12) Patent Application Publication
(10) Pub. No.: US 2020/0193540 A1
(43) Pub. Date: Jun. 18, 2020

(54) AUTOMATED SETTLEMENT OF A PROVISIONAL PAYMENT FOR A COMMODITY USING A DISTRIBUTED LEDGER

(71) Applicant: ABAXX TECHNOLOGIES INC., TORONTO (CA)

(72) Inventors: JOSHUA CRUMB, CHRIST CHURCH (BB); ANDREW FEDAK, CHRIST CHURCH (BB); CHRISTOPHER A. WIKLOF, EVERETT, WA (US)

(21) Appl. No.: 16/692,211

(22) Filed: Nov. 22, 2019

Related U.S. Application Data
(60) Provisional application No. 62/773,080, filed on Nov. 29, 2018.

(51) Int. Cl. G06Q 50/18; G06Q 20/14; G06Q 20/06

(52) U.S. Cl. CPC G06Q 50/18; G06Q 20/065; G06Q 20/14

(57) ABSTRACT

A computer method for making a smart contract for a commodity includes establishing, in a server computer, a provisional price for a commodity on a first date for delivery at a future second date, and establishing, in the server computer, a partial payment price on the first date corresponding to the commodity. The computer method includes receiving, into the server computer, the partial payment price from a purchaser of the commodity, and tracking a value for the commodity as time passes from the first date to the second date. The computer method includes establishing, with the server computer, a settlement price for the commodity on or after the second date, and transferring a net settlement value to or from the purchaser of the commodity

### CROSS-REFERENCE TO RELATED APPLICATIONS

The present application claims priority benefit from co-pending U.S. Provisional Patent Application No. 62/773,080, entitled “AUTOMATED SETTLEMENT OF A PROVISIONAL PAYMENT FOR A COMMODITY USING A DISTRIBUTED LEDGER,” filed Nov. 29, 2018 (docket number 3058-003-02), which application, to the extent not inconsistent with the disclosure herein, is incorporated herein by reference.

### SUMMARY

According to an embodiment, a computer method for making a smart contract for a commodity includes establishing, in a server computer, a provisional price for a commodity on a first date for delivery at a future second date, and establishing, in the server computer, a partial payment price on the first date corresponding to the commodity. The computer method includes receiving, into the server computer, the partial payment price from a purchaser of the commodity, and tracking a value for the commodity as time passes from the first date to the second date. The computer method includes establishing, with the server computer, a settlement price for the commodity on or after the second date, and transferring a net settlement value to or from the purchaser of the commodity.

According to an embodiment, a computer method for making a smart contract for a commodity includes establishing, in a server computer, an identity of an instance of a commodity, establishing, in the server computer, a provisional price for the instance of the commodity on a first date for delivery at a future second date, and establishing, in the server computer, a partial payment price on the first date corresponding to the instance of the commodity. The computer method includes recording, with the server computer, the identity of the instance of the commodity, the provisional price, and the partial payment price onto one or more computer storage media using a distributed ledger, and receiving, into the server computer, data corresponding to receipt of the partial payment from a purchaser of the commodity including a network transfer of value from a purchaser wallet. The computer method includes recording, with the server computer, the data corresponding to the receipt of the partial payment onto the one or more computer storage media using the distributed ledger, periodically tracking a value for the commodity as time passes from the first date to the second date, and recording the tracked value using the distributed ledger. The computer method includes establishing, with the server computer, a settlement price for the commodity on or after the second date as a function of the tracked commodity value, and transferring a net settlement value to or from a purchaser wallet corresponding to the purchaser of the commodity instance.

### BRIEF DESCRIPTION OF THE DRAWINGS

FIG. 1 is a flow chart showing a computer method for making a smart contract for a commodity, according to an embodiment.

FIG. 2 is a flow chart showing a computer method for making a smart contract for a commodity, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

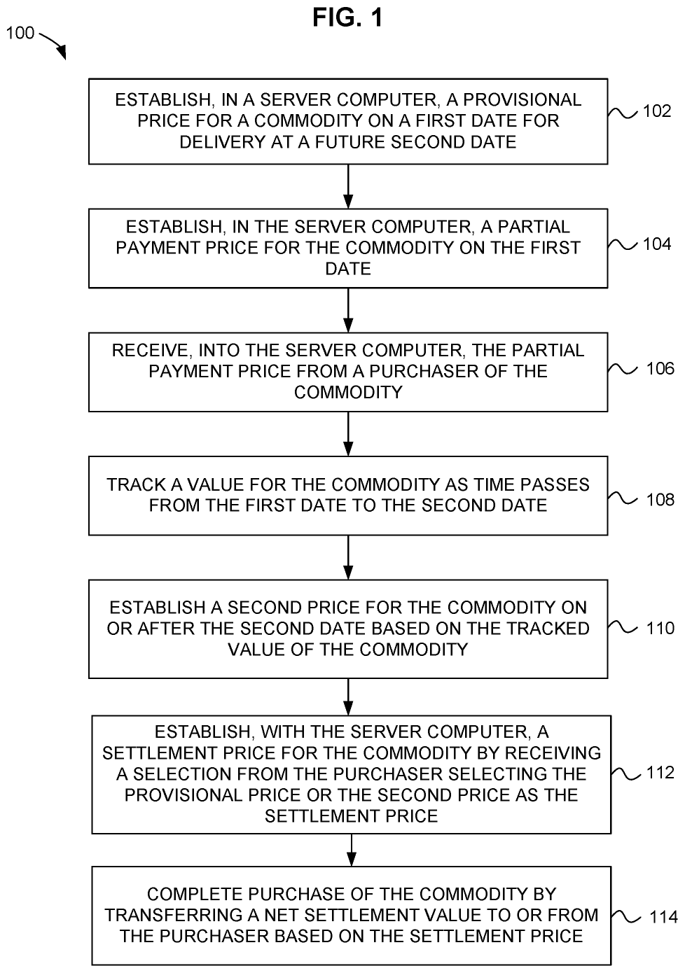

FIG. 1 is a flow chart showing a computer method 100 for making a smart contract for a commodity, according to an embodiment.

According to an embodiment, a computer method 100 for making a smart contract for a commodity includes, in step 102, establishing, in a server computer, a provisional price for a commodity on a first date for delivery at a future second date. Step 104 includes establishing, in the server computer, a partial payment price on the first date corresponding to the commodity. Step 106 includes receiving, into the server computer, the partial payment price from a purchaser of the commodity. Step 108 includes tracking a value for the commodity as time passes from the first date to the second date. Step 112 includes establishing, with the server computer, a settlement price for the commodity on or after the second date. Step 114 includes transferring a net settlement value to or from the purchaser of the commodity.

According to an embodiment, the computer method 100 further includes, in the server computer, transferring the net settlement value from or to a seller of the commodity.

According to an embodiment, the computer method 100 further includes establishing, with the server computer, a first margin reserve requirement on the first date, and receiving verification of the purchaser meeting the first margin reserve requirement. In an embodiment, the first margin reserve requirement includes requiring that the purchaser maintain, in an account of the purchaser, a reserve fund equal to at least a difference between the provisional price and the partial payment price. In an embodiment, the computer method 100 further includes earmarking the reserve fund for settling purchase of the commodity on or after the second date, and preventing, between the first date and the second date, expenditure from the account if the expenditure would result in a total reserve fund in the account less than the first margin reserve requirement. In an embodiment, the computer method 100 further includes establishing and/or adjusting a third margin reserve requirement on a third date between the first date and the second date different than the first date, and notifying the purchaser of the third margin reserve requirement.

According to an embodiment, the computer method 100 further includes determining the net settlement value as a difference between the settlement price and the partial payment price. In one embodiment, the computer method 100 further includes transferring the net settlement value, in step 114, to the purchaser if the partial payment price is greater than the settlement price. In an embodiment, transferring the net settlement value, in step 114, to the purchaser includes transferring the net settlement value from a seller of the commodity to the purchaser. In another embodiment, the computer method 100 further includes transferring the net settlement value, in step 114, from the purchaser if the partial payment price is less than the settlement price. In an embodiment, transferring the net settlement value, in step 114, from the purchaser includes transferring the net settlement value from the purchaser to the seller of the commodity.

According to an embodiment, the computer method 100 further includes, in step 110, establishing a second price for the commodity based on the value for the commodity on or after the second date. In an embodiment, the computer method 100 further includes providing an option to the purchaser to select either the provisional price or the second price as the settlement price. In one embodiment, establishing the settlement price, in step 112, includes receiving a selection from the purchaser selecting either the provisional price or the second price as the settlement price. In another embodiment, establishing the settlement price, in step 112, includes receiving a selection from the seller of the commodity selecting either the provisional price or the second price as the settlement price.

According to an embodiment, the smart contract includes or calls one or more logic processes for transmitting a banner or other notification to the purchaser to set the second price. According to an embodiment, the smart contract includes or calls one or more logic processes for selecting a most optimum second price from a predetermined set of formulas (e.g., set forth above), and includes or calls one or more logic processes for establishing the second price, as described in step 110. In an embodiment, the smart contract includes logic processes and/or calls to logic processes that reside on a distributed ledger or a secure resource operating as an oracle for the distributed ledger. In an embodiment, the smart contract is at least partially carried by a referenced storage service such as Inter Planetary File System (IPFS) or FileCoin, such that an address or encrypted address for the storage location is carried by the distributed ledger. In an embodiment, the smart contract resides on the distributed ledger, but stores corresponding data on referenced storage service.

According to an embodiment, the computer method 100 further includes establishing the settlement price as a lowest value between the provisional price and a tracked value of the commodity from the first date to the second date.

In one embodiment, the partial payment price is less than the provisional price. In another embodiment, the partial payment price is equal to the provisional price.

In an embodiment, the computer method 100 further includes facilitating the purchase of the commodity by the purchaser by negotiating and recording a smart contact in a distributed ledger. In one embodiment, negotiating and recording the smart contact in the distributed ledger includes establishing the provisional price. In another embodiment, negotiating and recording the smart contact in the distributed ledger includes establishing the partial payment price. In an embodiment, recording the smart contract includes recording the settlement price and the net settlement value in the distributed ledger. In one embodiment, the distributed ledger is a public blockchain. In another embodiment, the distributed ledger is a private blockchain. In another embodiment, the distributed ledger is a permission-based blockchain to which both the purchaser and the seller of the commodity have access.

In an embodiment, the provisional price and the partial payment price are established in a first cryptocurrency. In an embodiment, the settlement price and the net settlement value are determined in the first cryptocurrency. In one embodiment, the first cryptocurrency includes Bitcoin. In another embodiment, the first cryptocurrency includes Ethereum. In another embodiment, the first cryptocurrency includes XRP. In one embodiment, transferring the net settlement value includes transferring the net settlement value in the first cryptocurrency. In an embodiment, the settlement price and the net settlement value are determined in a second cryptocurrency different from the first cryptocurrency. In another embodiment, transferring the net settlement value includes transferring the net settlement value in the second cryptocurrency.

In an embodiment, the provisional price and the partial payment price are established in a fiat currency. In an embodiment, the fiat currency includes the U.S. dollar.

In an embodiment, receiving the partial payment price, in step 106, includes receiving commodity tokens based on the commodity. In one embodiment, the net settlement value is established in the commodity tokens.

In an embodiment, tracking the value for the commodity, in step 108, includes tracking the value in a server-based program.

In an embodiment, the commodity includes one or more of a product, a natural resource, a mining extraction, and/or a service.

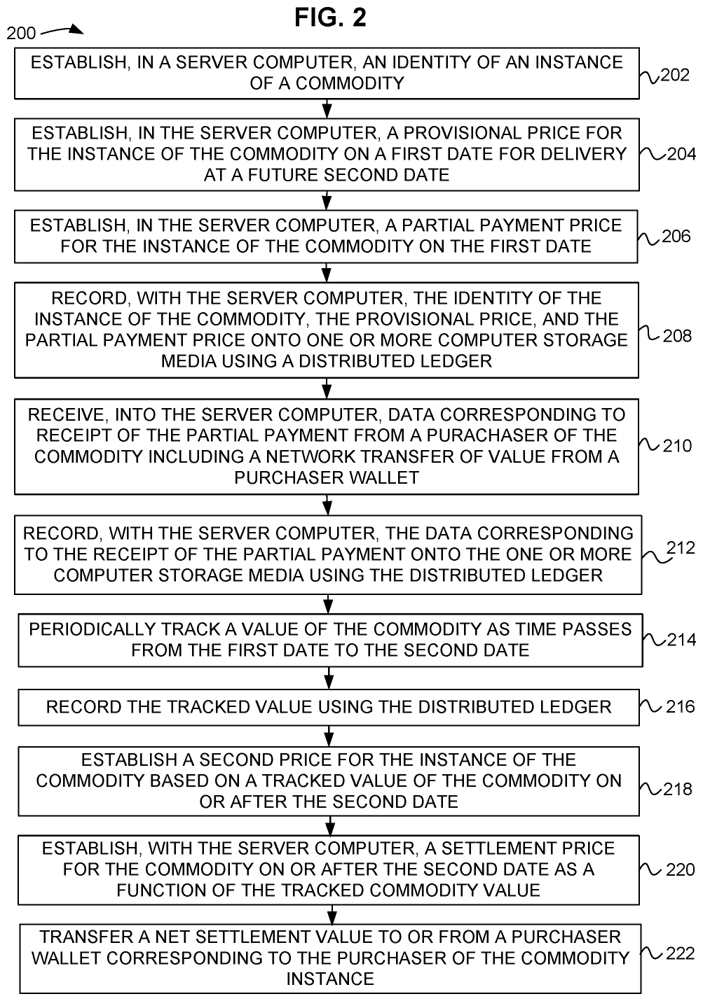

FIG. 2 is a flow chart showing a computer method 200 for making a smart contract for a commodity, according to an embodiment.

According to an embodiment, a computer method 200 for making a smart contract for a commodity includes, in step 202, establishing, in a server computer, an identity of an instance of a commodity. Step 204 includes establishing, in the server computer, a provisional price for the instance of the commodity on a first date for delivery at a future second date. Step 206 includes establishing, in the server computer, a partial payment price on the first date corresponding to the instance of the commodity. Step 208 includes recording, with the server computer, the identity of the instance of the commodity, the provisional price, and the partial payment price onto one or more computer storage media using a distributed ledger. Step 210 includes receiving, into the server computer, data corresponding to receipt of the partial payment from a purchaser of the commodity including a network transfer of value from a purchaser wallet. Step 212 includes recording, with the server computer, the data corresponding to the receipt of the partial payment onto the one or more computer storage media using the distributed ledger. Step 214 includes periodically tracking a value of the commodity as time passes from the first date to the second date. Step 216 includes recording the tracked value using the distributed ledger. Step 220 includes establishing, with the server computer, a settlement price for the commodity on or after the second date as a function of the tracked commodity value. Step 222 includes transferring a net settlement value to or from a purchaser wallet corresponding to the purchaser of the commodity instance.

According to an embodiment, recording data with the server computer, in step 212, includes transacting the data onto the distributed ledger. According to another embodiment, recording data with the server computer, in step 212, includes transacting the data onto the distributed ledger. Additionally and/or alternatively, recording data with the server computer, in step 212, includes saving the data onto an address of a referenced storage service and transacting the address of the reference storage service onto the distributed ledger.

According to an embodiment, the distributed ledger includes an Etherium blockchain. In an embodiment, periodically tracking the value of the commodity as time passes from the first date to the second date, in step 214, includes, in a Solidity environment, periodically and automatically triggering events based on a timer. According to another embodiment, periodically tracking the value of the commodity as time passes from the first date to the second date, in step 214, includes executing a “set interval( )” command as a JavaScript function.

According to an embodiment, the computer method 200 further includes, in the server computer, performing a network transfer of the net settlement value from or to a seller wallet corresponding to a seller of the identified commodity instance.

According to an embodiment, the computer method 200 further includes determining the net settlement value as a difference between the settlement price and the partial payment price. In one embodiment, the computer method 200 further includes transferring the net settlement value, in step 222, to the purchaser if the partial payment price is greater than the settlement price. In an embodiment, transferring the net settlement value, in step 222, to the purchaser includes transferring the net settlement value from a seller of the commodity instance to the purchaser. In another embodiment, the computer method 200 further includes transferring the net settlement value, in step 222, from the purchaser if the partial payment price is less than the settlement price. In an embodiment, transferring the net settlement value, in step 222, from the purchaser includes transferring the net settlement value from the purchaser to the seller of the commodity instance.

According to an embodiment, the computer method 200 further includes, in step 218, establishing a second price for the instance of the commodity based on a tracked value of the commodity on or after the second date.

According to an embodiment, receiving, into the server computer, the data corresponding to the receipt of the partial payment, in step 210, includes receiving commodity tokens based on the commodity. In one embodiment, the net settlement value is established in the commodity tokens.

According to an embodiment, periodically tracking the value of the commodity, in step 214, includes tracking the value in a server-based program.

According to an embodiment, the commodity includes one or more of a product, a natural resource, a fuel, a mining extraction, and a service.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A computer method for making a smart contract for a commodity, comprising:
establishing, in a server computer, a provisional price for a commodity on a first date for delivery at a future second date;
establishing, in the server computer, a partial payment price on the first date corresponding to the commodity;
receiving, into the server computer, the partial payment price from a purchaser of the commodity;
tracking a value for the commodity as time passes from the first date to the second date;
establishing, with the server computer, a settlement price for the commodity on or after the second date; and
transferring a net settlement value to or from the purchaser of the commodity.

2. The computer method for making a smart contract for a commodity of claim 1, further comprising:
in the server computer, transferring the net settlement value from or to a seller of the commodity.

3. The computer method for making a smart contract for a commodity of claim 1, further comprising:
establishing, with the server computer, a first margin reserve requirement on the first date; and
receiving verification of the purchaser meeting the first margin reserve requirement.

4. The computer method for making a smart contract for a commodity of claim 3, wherein the first margin reserve requirement includes requiring that the purchaser maintain, in an account of the purchaser, a reserve fund equal to at least a difference between the provisional price and the partial payment price.

5. The computer method for making a smart contract for a commodity of claim 4, further comprising:
earmarking the reserve fund for settling purchase of the commodity on or after the second date; and
preventing, between the first date and the second date, expenditure from the account if the expenditure would result in a total reserve fund in the account less than the first margin reserve requirement.

6. The computer method for making a smart contract for a commodity of claim 3, further comprising:
establishing a third margin reserve requirement on a third date between the first date and the second date different than the first date; and
notifying the purchaser of the third margin reserve requirement.

7. The computer method for making a smart contract for a commodity of claim 1, further comprising:
determining the net settlement value as a difference between the settlement price and the partial payment price.

8. The computer method for making a smart contract for a commodity of claim 7, further comprising:
transferring the net settlement value to the purchaser if the partial payment price is greater than the settlement price.

9. The computer method for making a smart contract for a commodity of claim 8, wherein transferring the net settlement value to the purchaser includes transferring the net settlement value from a seller of the commodity to the purchaser.

10. The computer method for making a smart contract for a commodity of claim 7, further comprising:
transferring the net settlement value from the purchaser if the partial payment price is less than the settlement price.

11. The computer method for making a smart contract for a commodity of claim 10, wherein transferring the net settlement value from the purchaser includes transferring the net settlement value from the purchaser to the seller of the commodity.

12. The computer method for making a smart contract for a commodity of claim 1, further comprising:
establishing a second price for the commodity based on the value for the commodity on or after the second date.

13. The computer method for making a smart contract for a commodity of claim 12, further comprising:
providing an option to the purchaser to select either the provisional price or the second price as the settlement price.

14. The computer method for making a smart contract for a commodity of claim 13, wherein establishing the settlement price includes receiving a selection from the purchaser selecting either the provisional price or the second price as the settlement price.

15. The computer method for making a smart contract for a commodity of claim 12, wherein establishing the settlement price includes receiving a selection from the seller of the commodity selecting either the provisional price or the second price as the settlement price.

16. The computer method for making a smart contract for a commodity of claim 1, further comprising establishing the settlement price as a lowest value between the provisional price and a tracked value of the commodity from the first date to the second date.

17. The computer method for making a smart contract for a commodity of claim 1, wherein the partial payment price is less than the provisional price.

18. The computer method for making a smart contract for a commodity of claim 1, wherein the partial payment price is equal to the provisional price.

19. The computer method for making a smart contract for a commodity of claim 1, further comprising:
facilitating the purchase of the commodity by the purchaser by negotiating and recording a smart contract in a distributed ledger.

20. The computer method for making a smart contract for a commodity of claim 19, wherein negotiating and recording the smart contract in the distributed ledger includes establishing the provisional price.

21. The computer method for making a smart contract for a commodity of claim 19, wherein negotiating and recording the smart contract in the distributed ledger includes establishing the partial payment price.

22. The computer method for making a smart contract for a commodity of claim 19, wherein recording the smart contract includes recording the settlement price and the net settlement value in the distributed ledger.

23. The computer method for making a smart contract for a commodity of claim 19, wherein the distributed ledger is a public blockchain.

24. The computer method for making a smart contract for a commodity of claim 19, wherein the distributed ledger is a private blockchain.

25. The computer method for making a smart contract for a commodity of claim 19, wherein the distributed ledger is a permission-based blockchain to which both the purchaser and the seller of the commodity have access.

26. The computer method for making a smart contract for a commodity of claim 1, wherein the provisional price and the partial payment price are established in a first cryptocurrency.

27. The computer method for making a smart contract for a commodity of claim 26, wherein the settlement price and the net settlement value are determined in the first cryptocurrency.

28. The computer method for making a smart contract for a commodity of claim 27, wherein the first cryptocurrency includes Bitcoin.

29. The computer method for making a smart contract for a commodity of claim 27, wherein the first cryptocurrency includes Ethereum.

30. The computer method for making a smart contract for a commodity of claim 27, wherein the first cryptocurrency includes XRP.

31. The computer method for making a smart contract for a commodity of claim 27, wherein transferring the net settlement value includes transferring the net settlement value in the first cryptocurrency.

32. The computer method for making a smart contract for a commodity of claim 26, wherein the settlement price and the net settlement value are determined in a second cryptocurrency different from the first cryptocurrency.

33. The computer method for making a smart contract for a commodity of claim 32, wherein transferring the net settlement value includes transferring the net settlement value in the second cryptocurrency.

34. The computer method for making a smart contract for a commodity of claim 1, wherein the provisional price and the partial payment price are established in a fiat currency.

35. The computer method for making a smart contract for a commodity of claim 34, wherein the fiat currency includes the U.S. dollar.

36. The computer method for making a smart contract for a commodity of claim 1, wherein receiving the partial payment price includes receiving commodity tokens based on the commodity.

37. The computer method for making a smart contract for a commodity of claim 36, wherein the net settlement value is established in the commodity tokens.

38. The computer method for making a smart contract for a commodity of claim 1, wherein tracking the value for the commodity includes tracking the value in a server-based program.

39. The computer method for making a smart contract for a commodity of claim 1, wherein the commodity includes one or more of a product, a natural resource, a fuel, a mining extraction, and a service.

40. A computer method for making a smart contract for a commodity, comprising:
establishing, in a server computer, an identity of an instance of a commodity;
establishing, in the server computer, a provisional price for the instance of the commodity on a first date for delivery at a future second date;
establishing, in the server computer, a partial payment price on the first date corresponding to the instance of the commodity;
recording, with the server computer, the identity of the instance of the commodity, the provisional price, and the partial payment price onto one or more computer storage media using a distributed ledger;
receiving, into the server computer, data corresponding to receipt of the partial payment from a purchaser of the commodity including a network transfer of value from a purchaser wallet;
recording, with the server computer, the data corresponding to the receipt of the partial payment onto the one or more computer storage media using the distributed ledger;
periodically tracking a value of the commodity as time passes from the first date to the second date;
recording the tracked value using the distributed ledger;
establishing, with the server computer, a settlement price for the commodity on or after the second date as a function of the tracked commodity value; and
transferring a net settlement value to or from a purchaser wallet corresponding to the purchaser of the commodity instance.

41. The computer method for making a smart contract for a commodity of claim 40, wherein recording data with the server computer includes transacting the data onto the distributed ledger.

42. The computer method for making a smart contract for a commodity of claim 40, wherein recording data with the server computer includes saving the data onto an address of a referenced storage service and transacting the address of the reference storage service onto the distributed ledger.

43. The computer method for making a smart contract for a commodity of claim 40, wherein the distributed ledger includes an Etherium blockchain; and
wherein periodically tracking the value of the commodity as time passes from the first date to the second date includes, in a Solidity environment, periodically and automatically triggering events based on a timer.

44. The computer method for making a smart contract for a commodity of claim 40, wherein periodically tracking the value of the commodity as time passes from the first date to the second date includes executing a “set interval( )” command as a JavaScript function.

45. The computer method for making a smart contract for a commodity of claim 40, further comprising:
in the server computer, performing a network transfer of the net settlement value from or to a seller wallet corresponding to a seller of the identified commodity instance.

46. The computer method for making a smart contract for a commodity of claim 40, further comprising:
determining the net settlement value as a difference between the settlement price and the partial payment price.

47. The computer method for making a smart contract for a commodity of claim 46, further comprising:
transferring the net settlement value to the purchaser if the partial payment price is greater than the settlement price.

48. The computer method for making a smart contract for a commodity of claim 47, wherein transferring the net settlement value to the purchaser includes transferring the net settlement value from a seller of the commodity instance to the purchaser.

49. The computer method for making a smart contract for a commodity of claim 46, further comprising:
transferring the net settlement value from the purchaser if the partial payment price is less than the settlement price.

50. The computer method for making a smart contract for a commodity of claim 49, wherein transferring the net settlement value from the purchaser includes transferring the net settlement value from the purchaser to the seller of the commodity instance.

51. The computer method for making a smart contract for a commodity of claim 40, further comprising:
establishing a second price for the instance of the commodity based on a tracked value of the commodity on or after the second date.

52. The computer method for making a smart contract for a commodity of claim 40, wherein receiving the partial payment price includes receiving commodity tokens based on the commodity.

53. The computer method for making a smart contract for a commodity of claim 52, wherein the net settlement value is established in the commodity tokens.

54. The computer method for making a smart contract for a commodity of claim 40, wherein tracking the value of the commodity includes tracking the value in a server-based program.

55. The computer method for making a smart contract for a commodity of claim 40, wherein the commodity includes one or more of a product, a natural resource, a fuel, a mining extraction, and a service.
